(19) United States
(12) Patent Application Publication
(10) Pub. No.: US 2009/0311962 A1
(43) Pub. Date: Dec. 17, 2009

(54) Communication Apparatus, Communication System, Communication Method and Program

(76) Inventors: Jun IWASAKI, Tokyo (JP); Satoshi KONYA, Kanagawa (JP); Tomonari YAMAGATA, Kanagawa (JP); Nobuo NAMEKAWA, Kanagawa (JP); Hiroaki MIYACHI, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/484,598

(22) Filed: Jun. 15, 2009

(30) Foreign Application Priority Data
Jun. 17, 2008 (JP) P2008-158450

(51) Int. Cl. H04B 7/00

(52) U.S. Cl. 455/41.2

(57) ABSTRACT

There is provided a communication apparatus including a first communication control unit for controlling a communication in a first communication method, a storage unit in which contact information of other communication apparatus in the first communication method is recorded, and a second communication control unit for controlling a connection establishment communication with a communication party in a second communication method based on electric field coupling or magnetic field coupling and a data communication with the communication party in the second communication method, wherein the second communication control unit does not make the data communication with the communication party when the contact information recorded in the storage unit is not contained in a signal transmitted from the communication party during the connection establishment communication.

### BACKGROUND OF THE INVENTION

1. Field of the Invention

The present invention relates to a communication apparatus, a communication system, a communication method and a program.

2. Description of the Related Art

In recent years, there has been broadly used a radio wave communication method prescribed in the IEEE (Institute of Electrical and Electronic Engineers) 802.11. The radio wave communication method is configured such that an antenna is used to transmit and receive a wireless radio wave, but the wireless radio wave interferes with a radio wave transmitted or received therearound, which may affect the communication.

There is proposed a short distance wireless communication method which uses electric field coupling or magnetic field coupling to make communication other than the radio wave communication method. In the short distance wireless communication method, for example, when a plurality of communication apparatuses for performing magnetic field coupling approach, the communication apparatuses magnetically couple so that a communication is realized between the communication apparatuses through magnetic field coupling. In this manner, according to the short distance wireless communication method utilizing electric field coupling or magnetic field coupling, since a signal is not transmitted if a communication party does not approach, an issue for the interference is difficult to occur, which is more advantageous than the radio wave communication method.

In such various communication methods, typically, after a connection establishment processing such as authentication processing is performed between two communication apparatuses, a data communication is started. For example, in Japanese Patent Application Laid-Open No. 2007-209034, there is described one example of a telephone for performing a connection establishment processing. Specifically, in Japanese Patent Application Laid-Open No. 2007-209034, there is described a telephone for making a telephone communication with a calling party apparatus if a phone number of the calling party apparatus coincides with a previously-registered phone number.

### SUMMARY OF THE INVENTION

Here, in a short distance wireless communication method based on electric field coupling or magnetic field coupling, since two communication apparatuses approach so that a communication is started, there has not been assumed a concept as contact information such as phone number or e-mail address used in the telephone. If contact information in the short distance wireless communication method is assigned to each communication apparatus, there is considered such that communication apparatuses permitting a data communication are restricted by the previous registration of the contact information as in the above telephone. However, when contact information in the short distance wireless communication method based on electric field coupling or magnetic field coupling is additionally registered in a communication apparatus, there has occurred an issue that a memory capacity of the communication apparatus is restricted.

The present invention has been made in views of the above issue, and it is desirable to provide a novel and improved communication apparatus, communication system, communication method and program capable of utilizing contact information recorded in relation to other communication system to restrict a communication party of a data communication based on electric field coupling or magnetic field coupling.

According to an embodiment of the present invention, there is provided a communication apparatus including a first communication control unit for controlling a communication in a first communication method, a storage unit in which contact information of other communication apparatus in the first communication method is recorded, and a second communication control unit for controlling a connection establishment communication with a communication party in a second communication method based on electric field coupling or magnetic field coupling and a data communication with the communication party in the second communication method. More specifically, the second communication control unit does not make the data communication with the communication party when the contact information recorded in the storage unit is not contained in a signal transmitted from the communication party during the connection establishment communication.

The communication apparatus further includes a third communication control unit for controlling a communication in a third communication method different from the first communication method and the second communication method, and the storage unit in which contact information of the other communication apparatus in the third communication method may further be recorded.

The second communication control unit may make the data communication with the communication party if at least either the contact information recorded in the storage unit in the first communication method or the contact information in the third communication method is contained in the signal transmitted from the communication party during the connection establishment communication. Further, both the contact information in the first communication method and the contact information in the third communication method may be contained in the signal transmitted from the communication party during the connection establishment communication.

Identification information indicating a communication method and the contact information of the communication party in the communication method indicated by the identification information may be contained in the signal transmitted from the communication party during the connection establishment communication.

The contact information of the communication party may be contained also in the signal transmitted from the communication party during the data communication, and the storage unit in which data received from the communication party during the data communication may be recorded in association with reception time information and the contact information contained in the signal.

The second communication control unit may request the communication party to transmit a signal containing contact information during the connection establishment communication.

According to another embodiment of the present invention, there is provided a communication system including a first communication apparatus having a first communication control unit for controlling a communication in a first communication method, a storage unit in which contact information of other communication apparatus in the first communication method is recorded and a second communication control unit for controlling a connection establishment communication in a second communication method based on electric field coupling or magnetic field coupling and a data communication in the second communication method, and a second communication apparatus for transmitting a signal containing contact information of the second communication apparatus in the first communication method during the connection establishment communication. More specifically, the second communication control unit does not make the data communication with the second communication apparatus if the contact information recorded in the storage unit is not contained in the signal transmitted from the second communication apparatus during the connection establishment communication.

According to another embodiment of the present invention, there is provided a communication method including the steps of: recording contact information of other communication apparatus in a first communication method in a storage medium; making a connection establishment communication with a communication party in a second communication method based on electric field coupling or magnetic field coupling; and controlling a data communication with the communication party in the second communication method. More specifically, the data communication with the communication party is not made if the contact information recorded in the storage medium is not contained in the signal transmitted from the communication party during the connection establishment communication.

According to another embodiment of the present invention, there is provided a program for causing a computer to function as a first communication control unit for controlling a communication in a first communication method, a recording unit for recording contact information of other communication apparatus in the first communication method in a storage medium and a second communication control unit for controlling a connection establishment communication with a communication party in a second communication method based on electric field coupling or magnetic field coupling and a data communication with the communication party in the second communication method so that the data communication with the communication party is not made when the contact information recorded in the storage medium is not contained in the signal transmitted from the communication party during the connection establishment communication.

According to another embodiment of the present invention, there is provided a communication apparatus including a first communication control unit for controlling a communication in a first communication method and a second communication control unit for controlling a connection establishment communication with a communication party in a second communication method based on electric field coupling and magnetic field coupling and a data communication with the communication party in the second communication method, wherein the second communication control unit transmits a signal containing contact information of the communication apparatus in the first communication method during the connection establishment communication.

According to the embodiments of the present invention described above, it is possible to restrict a communication party of a data communication based on electric field coupling or magnetic field coupling by utilizing contact information recorded in association with other communication method.

### BRIEF DESCRIPTION OF THE DRAWINGS

FIG. 1 is an explanatory diagram showing a communication system 1 according to one embodiment of the present invention;

FIG. 2 is a block diagram showing a hardware configuration of a cell phone;

FIG. 3 is a functional block diagram showing a configuration of the cell phone according to the present embodiment;

FIG. 4 is an explanatory diagram showing a configuration example of phone book data;

FIG. 5 is a functional block diagram showing a configuration of a short distance wireless communication control unit;

FIG. 6 is an explanatory diagram showing a configuration example of a connection establishment request;

FIG. 7 is a sequence diagram showing a flow of a first operation example of the cell phone according to the present embodiment;

FIG. 8 is a sequence diagram showing a flow of a second operation example of the cell phone according to the present embodiment; and

FIG. 9 is a sequence diagram showing a flow of a third operation example of the cell phone according to the present embodiment.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

“Detailed Description of the Preferred Embodiments” will be described according to the following item order.
[1] Outline of the present embodiment
[2] How the present embodiment is made
[3] Detailed description of the present embodiment
[3-1] Hardware configuration of cell phone
[3-2] Function of cell phone
[3-3] Operation of cell phone
(First operation example)
(Second operation example)
(Third operation example)
[4] Conclusion

### [1] Outline of the Present Embodiment

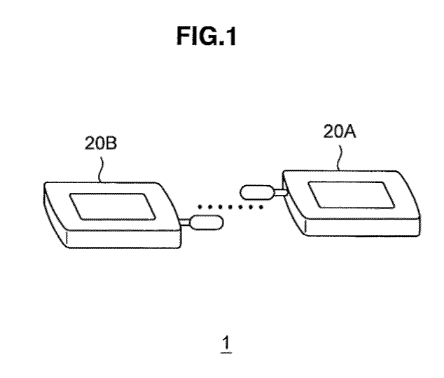

A communication system 1 according to one embodiment of the present invention will now be described with reference to FIG. 1.

FIG. 1 is an explanatory diagram showing the communication system 1 according to one embodiment of the present invention. As shown in FIG. 1, the communication system according to the present embodiment includes a pair of cell phones 20A and 20B (communication apparatuses). The cell phones 20A and 20B include an electrode plate called electric field coupler capable of electric field coupling with each other. When both the electric field couplers of the cell phones 20A and 20B approach within 3 cm, for example, a change in an inductive electric field generated by one electric field coupler is sensed by the other electric field coupler, thereby realizing an electric field communication between the cell phones 20A and 20B.

Specifically, in a pair of devices for making the above electric field communication, one of the pair functions as an initiator and the other functions as a responder. The initiator is directed for making a connection establishment request and the responder is directed for receiving the connection establishment request from the initiator.

For example, when the cell phone 20B shown in FIG. 1 functions as an initiator and the cell phone 20A functions as a responder, if the cell phones 20A and 20B approach each other, the cell phone 20A receives a connection establishment request transmitted from the cell phone 20B. Then, when the connection establishment request is received by the cell phone 20A, the cell phones 20A and 20B perform authentication processing as one example of the connection establishment processing, and when the authentication processing is normally terminated, the cell phones 20A and 20B are connected to each other in a data communicable state. The authentication processing includes, for example, a confirmation as to whether software versions or emulation systems indicating protocol are coincided between the cell phones 20A and 20B.

Thereafter, the cell phones 20A and 20B perform data communication on a one-to-one basis. More specifically, the cell phone 20B transmits arbitrary data to the cell phone 20A by an electric field coupler. Alternatively, the cell phone 20A transmits arbitrary data to the cell phone 20B by an electric field coupler. The arbitrary data includes audio data such as music, lecture or radio program, video data such as cinema, TV program, video program, photograph, document, picture and graphic, or game and software.

Since the intensity of the inductive field occurring from the electric field coupler is reversely proportional to the fourth power of the distance, whereas a radio wave emitted from an antenna attenuates in reverse proportion to the square of the distance, the distance between a pair of cell phones 20 capable of electric field communication can be advantageously restricted. In other words, with the electric field communication, there can be obtained effects that a signal hardly deteriorates due to surrounding obstacles and that a technique for preventing hacking or securing concealment can be simplified.

A radio wave emitted from an antenna has a transverse wave component oscillating in a direction orthogonal to the wave traveling direction and a polarized wave is present therein. To the contrary, since the electric field coupler generates an inductive electric field having a longitudinal wave component oscillating in the traveling direction and having no polarized wave, if the faces of the pair of electric field couplers are opposed to each other, a signal can be conveniently received at the reception side.

In the present specification, there will be described with emphasis an example in which a pair of cell phones 20 utilizes an electric field coupler to make a short distance wireless communication (non-contact communication), but the present invention is not limited to the example. For example, a pair of cell phones 20 can also make short distance wireless communication via a communication unit capable of communication through magnetic filed coupling. Further, the cell phones 20A and 20B can also make telephone communication or e-mail communication.

Further, the cell phones 20A and 20B are merely shown as one example of the communication apparatus in FIG. 1, and the preset invention is not limited to the example. For example, the communication apparatus may be an information processing device such as PC (personal computer), home video processing device (such as DVD recorder or video cassette recorder), cell phone, PHS (personal handyphone system), portable music player, portable video processing device, PDA (personal digital assistants), home game device, portable game device or household electrical appliance.

### [2] How the Present Embodiment is Made

As described above, in the short distance wireless communication, one pair of cell phones 20A and 20B approach each other so that a data communication between the pair of cell phones 20A and 20B is started. Thus, in the short distance wireless communication, user's convenience can be improved while user unintended data communication may be made.

For example, there was an issue that when a user in a crowded train has a cell phone related to the present embodiment, the cell phone of the user and a cell phone of a third party approach each other without user's intention so that data is sent into the cell phone of the user. Alternatively, there was an issue that the data in the cell phone of the user may be acquired by the cell phone of the third party without user's intention.

Thus, the cell phone 20 according to the present embodiment has been made in views of the above circumstances. The cell phone 20 according to the present embodiment can prevent user unintended data communication. The cell phone 20 according to the present embodiment will be described below in detail.

### [3] Detailed Description of the Present Embodiment

### [3-1] Hardware Configuration Cell Phone

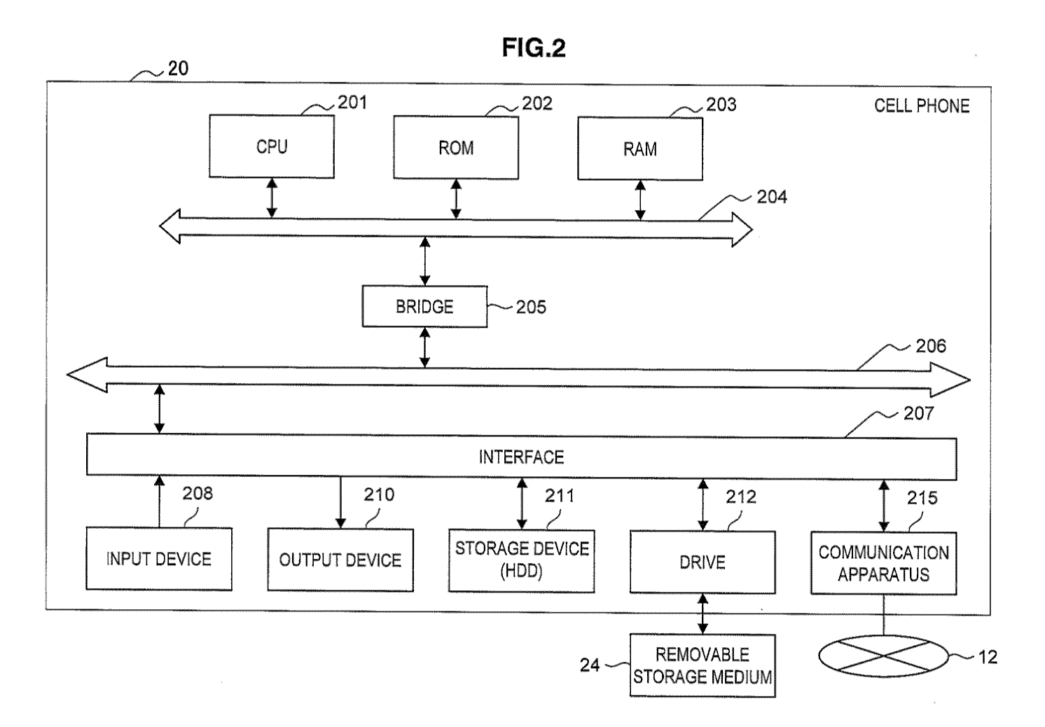

A hardware configuration of the cell phone 20 according to the present embodiment will now be described with reference to FIG. 2.

FIG. 2 is a block diagram showing a hardware configuration of the cell phone 20. The cell phone 20 includes a CPU (Central Processing Unit) 201, a ROM (Read Only Memory) 202, a RAM (Random Access Memory) 203, a host bus 204, a bridge 205, an external bus 206, an interface 207, an input device 208, an output device 210, a storage device (HDD) 211, a drive 212 and a communication device 215.

The CPU 201 functions as a calculation processing device and a control device and controls the entire operation within the cell phone 20 according to various programs. Further, the CPU 201 may be a microprocessor. The ROM 202 stores therein programs or calculation parameters used by the CPU 201. The RAM 203 primarily stores therein programs used for execution of the CPU 201 or parameters appropriately changing for the execution. These are interconnected via the host bus 204 composed of the CPU bus or the like.

The host bus 204 is connected to the external bus 206 such as PCI (Peripheral Component Interconnect/Interface) bus via the bridge 205. The host bus 204, the bridge 205 and the external bus 206 does not necessarily need to be configured in a separated manner and the functions thereof may be mounted on one bus.

The input device 208 includes an input means for user's inputting information such as mouse, keyboard, touch panel, button, microphone, switch and lever, and an input control circuit for generating and outputting an input signal based on the user's input to the CPU 201. The user of the cell phone 20 can input various items of data and instruct a processing operation to the cell phone 20 through the operation of the input device 208.

The output device 210 includes a display device such as CRT (Cathode Ray Tube) display device, liquid crystal display (LCD) device, OLED (Organic Light Emitting Display) device and lamp, and an audio output device such as speaker and headphone. The output device 210 outputs reproduced contents, for example. Specifically, the display device displays various items of information such as reproduced video data in the form of text or image. On the other hand, the audio output device converts reproduced audio data into audio and outputs the same.

The storage device 211 is directed for data storage. The storage device 211 may include a storage medium, a recording device for recording data in the storage medium, a reading device for reading out the data from the storage medium and a deletion device for deleting the data recorded in the storage medium. The storage device 211 includes a HDD (Hard Disk Drive), for example. The storage device 211 drives the hard disk to store therein the programs executed by the CPU 201 or various items of data. For example, phone book data described later are recorded in the storage device 211 records.

The drive 212 is a reader/writer for storage medium and is incorporated inside or attached outside the cell phone 20. The drive 212 reads out and outputs the information recorded in the removable recording medium 24 such as mounted magnetic disk, optical disk, magnetooptical disk or semiconductor memory to the RAM 203.

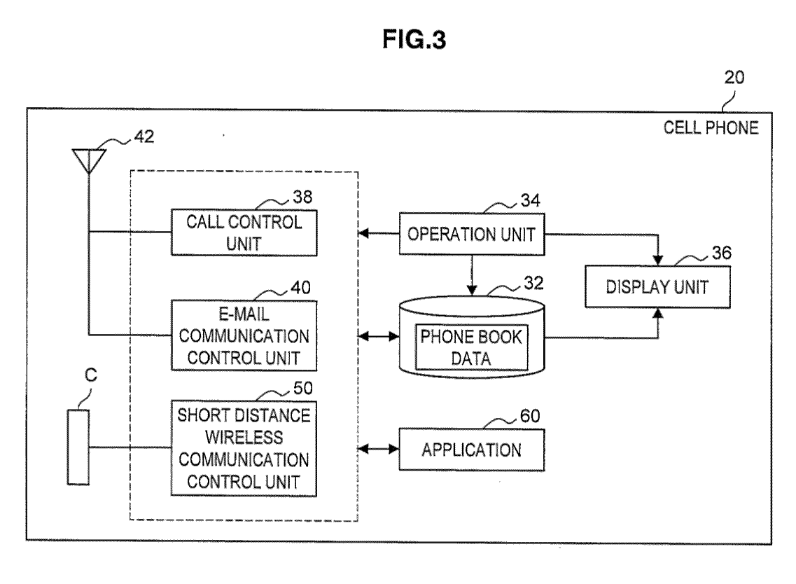

The communication device 215 is a communication interface configured of a communication device for connecting to the communication network 12, for example. Specifically, the communication device 215 corresponds to a device such as antenna (antenna 42 in FIG. 3) or wireless chip for making telephone communication and e-mail communication, and an electric field coupler (electric field coupler C in FIG. 3) for making short distance wireless communication.

### [3-2] Function of Cell Phone

The hardware configuration of the cell phone 20 according to the present embodiment has been described with reference to FIG. 2 hereinabove. In the following, the function of the cell phone 20 will be described with reference to FIGS. 3 to 6.

FIG. 3 is a functional block diagram showing a configuration of the cell phone 20 according to the present embodiment. As shown in FIG. 3, the cell phone 20 according to the present embodiment includes a storage unit 32, an operation unit 34, a display unit 36, a call control unit 38, an e-mail communication control unit 40, an antenna 42, a short distance wireless communication control unit 50, an application 60 and an electric field coupler C.

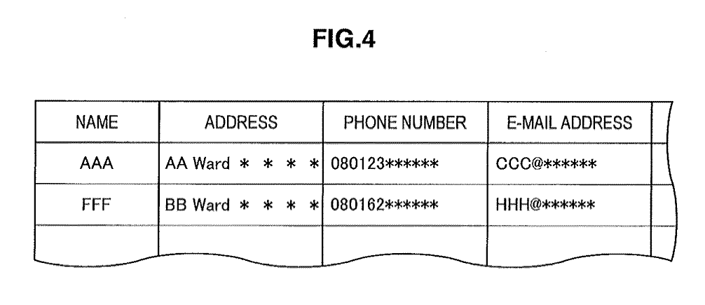

The storage unit 32 is a storage medium in which phone book data of other communication apparatus and reception data are recorded. Hereinafter, a configuration example of the phone book data will be described with reference to FIG. 4.

FIG. 4 is an explanatory diagram showing the configuration example of the phone book data. As shown in FIG. 4, in the phone book data, contact information such as owner's name, address, phone number and e-mail address is associated for each other communication apparatus. The cell phone 20 can call a communication apparatus owned by a specific user or specify a sender of a received e-mail based on the phone book data.

The storage unit 32 in which the phone book data are recorded may be a storage medium including non-volatile memory such as EEPROM (Electrically Erasable Programmable Read-Only Memory) and EPROM (Erasable Programmable Read Only Memory), magnetic disk such as hard disk and disk-shaped magnetic disk, optical disk such as CD-R (Compact Disc Recordable)/RW (ReWritable), DVD-R (Digital Versatile Disc Recordable)/RW/+R/+RW/RAM (Random Access Memory) and BD (Blu-Ray Disc (registered trademark)-R/BD-RE, or MO (Magneto Optical) Disk.

The operation unit 34 (corresponding to the input device 208 shown in FIG. 2, for example) is an interface between the cell phone 20 and the user. The user can input various items of data or various instructions into the cell phone 20 through the operation of the operation unit 34. The display unit 36 (corresponding to the output device 210 shown in FIG. 2, for example) displays a screen in response to the user's operation for the operation unit 34 or a screen indicating an originator at the time of incoming.

The call control unit 38 functions as a first communication control unit for controlling a telephone communication (first communication method) with other communication apparatus. For example, the call control unit 38 converts user's audio data acquired from a microphone into a form transmittable from the antenna 42, and transmits the audio data from the antenna 42 to a communication apparatus selected from the phone book data. Further, the call control unit 38 demodulates and decodes the audio data received by the antenna 42.

The e-mail communication control unit 40 functions as a third communication control unit for controlling an e-mail communication (third communication method) with other communication apparatus. For example, the e-mail communication control unit 40 converts e-mail data input by the user through the operation unit 34 into a form transmittable from the antenna 42, and transmits the e-mail data from the antenna 42 to a communication apparatus selected from the phone book data. Further, the e-mail communication control unit 40 demodulates and decodes the e-mail data received by the antenna 42.

The antenna 42 is an interface with other communication apparatus, and receives audio data or e-mail data transmitted from other communication apparatus on the radio wave or transmits the audio data or the e-mail data to the other communication apparatus on the radio wave.

The electric field coupler C functions as a communication unit for making communication through electric field coupling with an electric field coupler of an approaching communication apparatus as described in “[1] Outline of the present embodiment.”

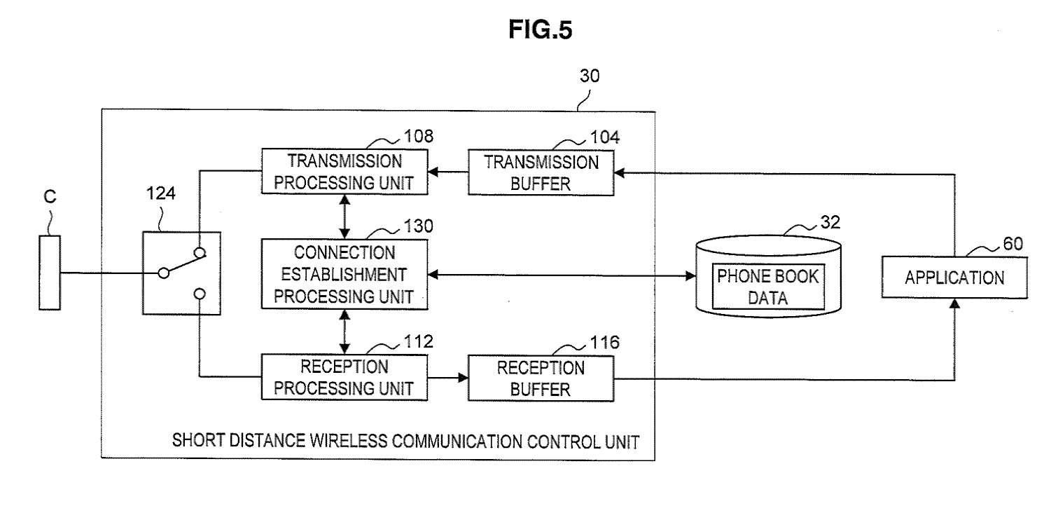

The short distance wireless communication control unit 50 functions as a second communication control unit for controlling a short distance wireless communication (second communication method) based on electric field coupling with other communication apparatus. For example, the short distance wireless communication control unit 50 transmits data supplied from the application 60 from the electric field coupler C or supplies the data received by the electric field coupler C to the application 60. Hereinafter, the function of the short distance wireless communication control unit 50 will be described in detail with reference to FIG. 5.

FIG. 5 is a functional block diagram showing a configuration of the short distance wireless communication control unit 50. As shown in FIG. 5, the short distance wireless communication control unit 50 includes a transmission buffer 104, a transmission processing unit 108, a reception processing unit 112, a reception buffer 116, a selector 124 and a connection establishment processing unit 130.

The transmission buffer 104 is a storage medium holding therein transfer data (transmission data) to be transferred from the electric field coupler C to other communication apparatus. The transfer data is supplied from the application 60, for example.

The transmission processing unit 108 performs a signal processing for converting transfer data input from the transmission buffer 104 or connection data for connection establishment request input from the connection establishment processing unit 130 into a signal form transmittable from the electric field coupler C.

The reception processing unit 112 performs a decode processing on the data received by the electric field coupler C. For example, the reception processing unit 112 may down-convert the data received by the electric field coupler C as a high frequency signal into a baseband signal and obtain a bit string based on a constellation.

The reception buffer 116 is a storage medium holding therein the data decoded by the reception processing unit 112. The data held in the reception buffer 116 may be supplied to the application 60 or recorded in the storage unit 32, for example.

The selector 124 selectively connects the electric field coupler C and the transmission processing unit 108 or the reception processing unit 112. More specifically, the electric field coupler C is connected to the transmission processing unit 108 by the selector 124 at the time of the transmission of the cell phone 20, and the electric field coupler C is connected to the reception processing unit 112 by the selector 124 at the time of the reception.

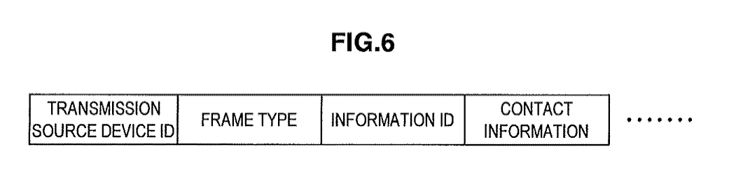

The connection establishment processing unit 130 performs a connection establishment processing (connection establishment communication) necessary when a data communication is made between the cell phone 20 and other communication apparatus. For example, when the cell phone 20 functions as an initiator, the connection establishment processing unit 130 outputs a connection establishment request to the transmission processing unit 108 and transmits the connection establishment request from the electric field coupler C when the other communication apparatus and the electric field coupler C approach each other. The connection establishment processing unit 130, as shown in FIG. 6, may contain the contact information of the cell phone in a different communication method in the connection establishment request to be transmitted from the electric field coupler C.

FIG. 6 is an explanatory diagram showing a configuration example of the connection establishment request. As shown in FIG. 6, the connection establishment request contains an information ID and contact information in addition to a transmission source device ID and a frame type indicating that the frame is the connection establishment request.

The information ID is information indicating any one communication method different from the short distance wireless communication method. The contact information describes therein the information depending on the communication method indicated by the information ID. For example, when the information indicating the telephone communication method is described in the information ID, the contact information describes therein the phone number of the cell phone 20. Similarly, when the information indicating the e-mail communication method is described in the information ID, the contact information describes therein the e-mail address of the cell phone 20. With the above configuration, a type of the contact information to be retrieved from the phone book data can be specified based on the information ID at the reception side of the connection establishment request.

FIG. 6 shows the example in which only one item of contact information is described in the connection establishment request, but the connection establishment request may describe therein several items of contact information such as both the phone number and the e-mail address.

Further, when the cell phone 20 functions as a responder and receives a connection establishment request from other communication apparatus, the connection establishment processing unit 130 determines whether the contact information contained in the connection establishment request is registered in the phone book data. Then, when the contact information contained in the connection establishment request is not registered in the phone book data, the connection establishment processing unit 130 denies the connection establishment request from the other communication apparatus and terminates the communication with the other communication apparatus.

On the other hand, when the contact information contained in the connection establishment request is registered in the phone book data, the connection establishment processing unit 130 transmits ACK in response to the connection establishment request to the other communication apparatus via the transmission processing unit 108. When several items of contact information are contained in the connection establishment request, the connection establishment processing unit 130 may determine whether at least one item of contact information is registered in the phone book data. Then, when at least one item of contact information is registered in the phone book data, the connection establishment processing unit 130 may transmit ACK. For example, when the other communication apparatus transmits the connection establishment request containing both the phone number and the e-mail address as the contact information and either the phone number or the e-mail address contained in the connection establishment request is registered in the phone book data, the connection establishment processing unit 130 may transmit ACK, In the actual usage of the cell phone 20, it is also assumed that only one of the phone number and the e-mail address of a certain user is registered in the phone book data. More specifically, it may be assumed that only a phone number of a user “A” is registered in the phone book data of the cell phone 20 and only an e-mail address of a user “B” is registered therein. Therefore, as described above, at least two types of the phone number and the e-mail address are advantageously transmitted as one example of several types of contact information. A series of communications including the transmission/reception of the connection establishment request and the ACK may be called a connection establishment communication in this manner.

When other communication apparatus receives ACK from the cell phone 20, it can start the data transmission to the cell phone 20. The other communication apparatus may additionally transmit the contact information of the apparatus and the current time along with the data. In this case, the cell phone 20 may supply the contact information and the current time, which are added to the data, to the application 60 in an associated manner or record the same in the storage unit 32. With the above configuration, the cell phone 20 can grasp when and from whom the data has been transmitted for each received data.

### [3-3] Operation of Cell Phone

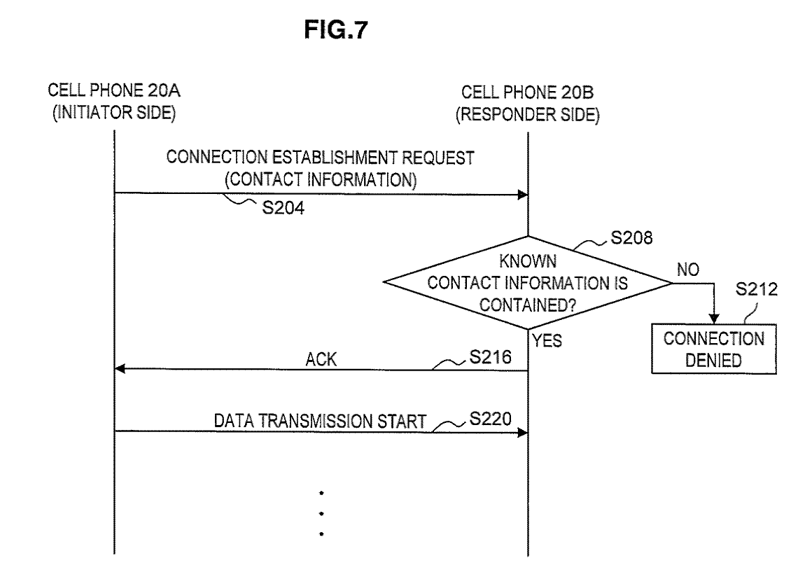

The function of the cell phone 20 according to the present embodiment has been described hereinbefore with reference to FIGS. 3 to 6. In the following, a communication method performed in the cell phone 20 according to the present embodiment will be described with reference to FIGS. 7 to 9.

### FIRST OPERATION EXAMPLE

FIG. 7 is a sequence diagram showing a flow of a first operation example of the cell phone 20 according to the present embodiment. At first, as shown in FIG. 7, when the cell phone 20A functioning as an initiator approaches the cell phone 20B functioning as a responder, the cell phone 20A transmits a connection establishment request containing the contact information such as phone number or e-mail address of the cell phone 20A (S204). The connection establishment processing unit 130 of the cell phone 20B determines whether the contact information contained in the connection establishment request received from the cell phone 20A is registered in the phone book data (S208).

When the contact information contained in the connection establishment request received from the cell phone 20A is not registered in the phone book data (S208), the connection establishment processing unit 130 of the cell phone 20B denies the connection establishment request from the cell phone 20A (S212). In other words, the connection establishment processing unit 130 of the cell phone 20B terminates the communication with the cell phone 20A. When the connection establishment processing unit 130 of the cell phone 20B denies the connection establishment request from the cell phone 20A, the connection establishment processing unit 130 of the cell phone 20B may transmit a response indicating the fact from the transmission processing unit 108.

On the other hand, when the contact information contained in the connection establishment request received from the cell phone 20A is registered in the phone book data, the connection establishment processing unit 130 of the cell phone 20B transmits ACK in response to the connection establishment request from the transmission processing unit 108 to the cell phone 20A (S216). When the cell phone 20A receives ACK from the cell phone 20B, it starts the data transmission to the cell phone 20B (S220).

As described above, according to the first operation example of the cell phone 20 of the present embodiment, the communication apparatus capable of the data transmission to the cell phone 20B functioning as a responder can be limited to a communication apparatus whose contact information is registered in the phone book data of the cell phone 20B. Therefore, it is possible to prevent the data from being transmitted from a third party's communication apparatus to the cell phone 20B without the cell phone 20B user's intention.

### SECOND OPERATION EXAMPLE

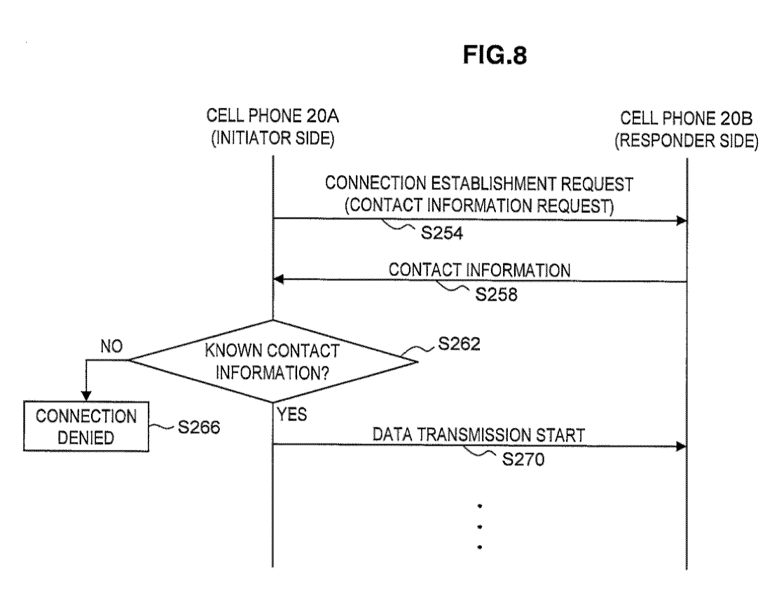

FIG. 8 is a sequence diagram showing a flow of a second operation example of the cell phone 20 according to the present embodiment. At first, as shown in FIG. 8, when the cell phone 20A functioning as an initiator approaches the cell phone 20B functioning as a responder, it transmits a connection establishment request (S254). When the connection establishment processing unit 130 of the cell phone 20B receives the connection establishment request received from the cell phone 20A, it transmits the contact information of the cell phone 20B (S258). The connection establishment request transmitted from the cell phone 20A in step S254 may contain information for requesting the contact information of the cell phone 20B.

Subsequently, the connection establishment processing unit 130 of the cell phone 20A determines whether the contact information received from the cell phone 20B is registered in the phone book data (S262). Then, when the contact information received from the cell phone 20B is not registered in the phone book data, the connection establishment processing unit 130 of the cell phone 20A does not make a connection establishment with the cell phone 20B (S266). In other words, the connection establishment processing unit 130 of the cell phone 20A terminates the communication with the cell phone 20B. When the connection establishment processing unit 130 of the cell phone 20A does not make the connection establishment with the cell phone 20B, it may transmit the information indicating the fact from the transmission processing unit 108.

On the other hand, when the contact information received from the cell phone 20B is registered in the phone book data, the connection establishment processing unit 130 of the cell phone 20A starts the data transmission to the cell phone 20B (S270).

As described above, according to the second operation example of the cell phone 20 of the present embodiment, the communication apparatus capable of the data reception from the cell phone 20A functioning as an initiator can be limited to a communication apparatus whose contact information is registered in the phone book data of the cell phone 20A. Therefore, it is possible to prevent the data of the cell phone 20A from being acquired by a third party's communication apparatus without the cell phone 20A user's intention.

### THIRD OPERATION EXAMPLE

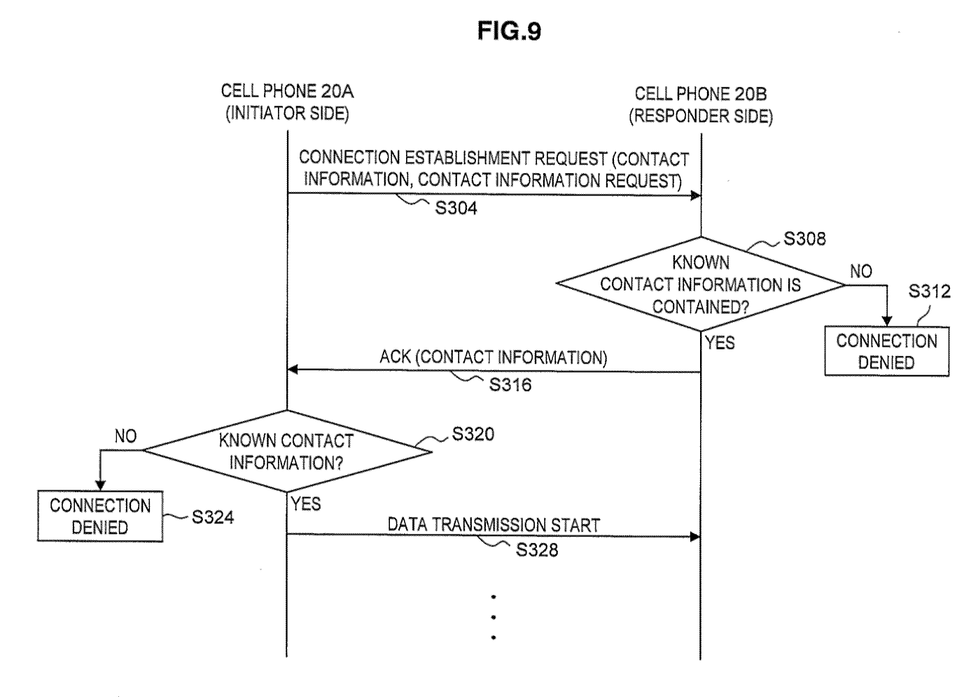

FIG. 9 is a sequence diagram showing a flow of a third operation example of the cell phone 20 according to the present embodiment. At first, as shown in FIG. 9, when the cell phone 20A functioning as an initiator approaches the cell phone 20B functioning as a responder, it transmits a connection establishment request containing the contact information such as phone number or e-mail address of the cell phone 20A (S304). The connection establishment processing unit 130 of the cell phone 20B determines whether the contact information contained in the connection establishment request received from the cell phone 20A is registered in the phone book data (S308).

Then, when the contact information contained in the connection establishment request received from the cell phone 20A is not registered in the phone book data (S308), the connection establishment processing unit 130 of the cell phone 20B denies the connection establishment request from the cell phone 20A (S312). In other words, the connection establishment processing unit 130 of the cell phone 20B terminates the communication with the cell phone 20A. When the connection establishment processing unit 130 of the cell phone 20B denies the connection establishment request from the cell phone 20A, it may transmit the response indicating the fact from the transmission processing unit 108.

On the other hand, when the contact information contained in the connection establishment request received from the cell phone 20A is registered in the phone book data, the connection establishment processing unit 130 of the cell phone 20B transmits ACK containing the contact information of the cell phone 20B from the transmission processing unit 108 to the cell phone 20A (S316).

Subsequently, the connection establishment processing unit 130 of the cell phone 20A determines whether the contact information contained in the ACK received from the cell phone 20B is registered in the phone book data (S320). Then, when the contact information contained in the ACK received from the cell phone 20B is not registered in the phone book data, the connection establishment processing unit 130 of the cell phone 20A does not make the connection establishment with the cell phone 20B (S324). In other words, the connection establishment processing unit 130 of the cell phone 20A terminates the communication with the cell phone 20B. When the connection establishment processing unit 130 of the cell phone 20A does not make the connection establishment with the cell phone 20B, it may transmit the information indicating the fact from the transmission processing unit 108.

On the other hand, when the contact information contained in the ACK received from the cell phone 20B is registered in the phone book data, the connection establishment processing unit 130 of the cell phone 20A starts the data transmission to the cell phone 20B (S328).

As described above, according to the third operation example of the cell phone 20 of the present embodiment, the data communication between the cell phones 20A and 20B can be made when both the cell phones 20A and 20B register each other's contact information. Therefore, even when the contact information of the cell phone 20A or 20B is leaked to a third party, the data communication between the cell phone 20A or 20B and the third party's communication apparatus can be prevented.

### [4] Conclusion

As described above, the cell phone 20 according to the present embodiment can limit the communication apparatus as a communication party of the data communication in the short distance wireless communication to a communication apparatus whose contact information is registered in the phone book data. Thus, even when the third party's communication apparatus approaches the cell phone 20 in a crowded train, for example, it is possible to prevent the data (such as user unwanted advertisement data or harmful data) from being transmitted from the third party's communication apparatus to the cell phone 20. Similarly, according to the present embodiment, it is possible to prevent the data of the cell phone 20 from being acquired by the third party's communication apparatus without the cell phone 20 user's intention.

According to the present embodiment, it is possible to limit the communication party in the short distance wireless communication based on the phone book data originally held by the cell phone 20. In other words, according to the present embodiment, new information for limiting the communication parry does not need to be recorded in the cell phone 20, thereby preventing a waste of the memory capacity of the storage unit 32 of the cell phone 20 or an increase in the circuit scale.

It should be understood by those skilled in the art that various modifications, combinations, sub-combinations and alterations may occur depending on design requirements and other factors insofar as they are within the scope of the appended claims or the equivalents thereof.

For example, the present embodiment has been described with emphasis on the example in which a phone number or e-mail address corresponds to contact information, but the present invention is not limited to the example. For example, modified information (such as hash value) of an address, name, phone number or e-mail address, an apparatus specific ID and the like may be used as the contact information. Further, the embodiment has been described by exemplifying the phone communication method and the e-mail communication method as one example of the communication method different from the short distance wireless communication method but an arbitrary communication method may be applied to the present embodiment.

The example in which data is transmitted from the cell phone 20 functioning as an initiator has been described in “[3-3] Operation of cell phone” but the present invention is not limited to the example. For example, the cell phone 20B functioning as a responder shown in FIG. 7 may start the data transmission to the cell phone 20A after the transmission of ACK in step S216.

The example in which a communication is made between the cell phones 20A and 20B as one example of the communication apparatus has been described in the present embodiment but the present invention is not limited to the example. For example, the present invention can be applied to a communication between the cell phone 20 and a PC. More specifically, a communication may be continued when the PC transmits a connection establishment request containing an e-mail address of the PC and the e-mail address contained in the connection establishment request is registered in the cell phone 20. Alternatively, a communication may be continued when the cell phone 20 transmits a connection establishment request containing an e-mail address of the cell phone 20, and the e-mail address contained in the connection establishment request is registered in the PC.

Each step in the processing of the cell phone 20 in the present specification does not necessarily need to be processed in time line in the order described in the sequence diagram. For example, each step in the processing of the cell phone 20 may include a processing performed in parallel or individually (such as parallel processing or object processing).

Further, there can be created a computer program for causing hardware such as the CPU 201, the ROM 202 and RAM 203 incorporated in the cell phone 20 to exhibit similar function as each configuration of the cell phone 20 described above. A storage medium in which the computer program is stored is also provided. The respective function blocks illustrated in the functional block diagrams of FIGS. 3 and 5 are configured in hardware, thereby realizing a series of processing in hardware.

The present application contains subject matter related to that disclosed in Japanese Priority Patent Application JP 2008-158450 filed in the Japan Patent Office on Jun. 17, 2008, the entire content of which is hereby incorporated by reference.

What is claimed is:

1. A communication apparatus comprising:
a first communication control unit for controlling a communication in a first communication method;
a storage unit in which contact information of other communication apparatus is recorded in the first communication method; and
a second communication control unit for controlling a connection establishment communication with a communication party in a second communication method based on electric field coupling or magnetic field coupling and a data communication with the communication party in the second communication method,
wherein the second communication control unit does not make the data communication with the communication party when the contact information recorded in the storage unit is not contained in a signal transmitted from the communication party during the connection establishment communication.

2. The communication apparatus according to claim 1, further comprising a third communication control unit for controlling a communication in a third communication method different from the first communication method and the second communication method,
wherein contact information of the other communication apparatus in the third communication method is further recorded in the storage unit.

3. The communication apparatus according to claim 2, wherein the second communication control unit makes the data communication with the communication party when at least either the contact information recorded in the storage unit in the first communication method or the contact information in the third communication method is contained in the signal transmitted from the communication party during the connection establishment communication.

4. The communication apparatus according to claim 3, wherein both the contact information in the first communication method and the contact information in the third communication method are contained in the signal transmitted from the communication party during the connection establishment communication.

5. The communication apparatus according to claim 2, wherein identification information indicating a communication method and contact information of the communication party in the communication method indicated by the identification information are contained in the signal transmitted from the communication party during the connection establishment communication.

6. The communication apparatus according to claims 1 to 5, wherein the contact information of the communication party is contained also in a signal transmitted from the communication party during the data communication, and
the storage unit in which the data received from the communication party is recorded during the data communication in association with reception time information and the contact information contained in the signal.

7. The communication apparatus according to claims 1 to 5, wherein the second communication control unit requests the communication party to transmit a signal containing contact information during the connection establishment communication.

8. A communication system comprising:
a first communication apparatus including:
a first communication control unit for controlling a communication in a first communication method;
a storage unit in which contact information of other communication apparatus in the first communication method is recorded; and
a second communication control unit for controlling a connection establishment communication in a second communication method based on electric field coupling or magnetic field coupling and a data communication in the second communication method; and
a second communication apparatus for transmitting a signal containing contact information of the second communication apparatus in the first communication method during the connection establishment communication,
wherein the second communication control unit does not make the data communication with the second communication apparatus when the contact information recorded in the storage unit is not contained in the signal transmitted from the second communication apparatus during the connection establishment communication.

9. A communication method comprising the steps of:
recording contact information of other communication apparatus in a first communication method in a storage medium;
making a connection establishment communication with a communication party in a second communication method based on electric field coupling or magnetic field coupling; and
controlling a data communication with the communication party in the second communication method,
wherein the data communication with the communication party is not made when the contact information recorded in the storage medium is not contained in a signal transmitted from the communication party during the connection establishment communication.

10. A program for causing a computer to function as:
a first communication control unit for controlling a communication in a first communication method;
a recording unit for recording contact information of other communication apparatus in the first communication method in a storage medium; and
a second communication control unit for controlling a connection establishment communication with a communication party in a second communication method based on electric field coupling or magnetic field coupling and a data communication with the communication party in the second communication method so that the data communication with the communication party is not made when the contact information recorded in the storage unit is not contained in a signal transmitted from the communication party during the connection establishment communication.

11. A communication apparatus comprising:
a first communication control unit for controlling a communication in a first communication method; and
a second communication control unit for controlling a connection establishment communication with a communication party in a second communication method based on electric field coupling or magnetic field coupling and a data communication with the communication party in the second communication method,
wherein the second communication control unit transmits a signal containing contact information of the communication apparatus in the first communication method during the connection establishment communication.
